(19) United States
(12) Patent Application Publication
(10) Pub. No.: US 2017/0235150 A1
(43) Pub. Date: Aug. 17, 2017

(54) Device for Shaping Laser Radiation

(71) Applicant: LIMO Patentverwaltung GmbH & Co. KG, Dortmund (DE)

(72) Inventor: Klaus BAGSCHIK, BONN (DE)

(21) Appl. No.: 15/420,461

(22) Filed: Jan. 31, 2017

(30) Foreign Application Priority Data
Feb. 15, 2016 (DE) 10 2016 102 591.7

(51) Int. Cl. G02B 27/09

(52) U.S. Cl. CPC G02B 27/0927; G02B 27/0938; G02B 27/0977; G02B 27/0916; G02B 27/0961

(57) ABSTRACT

A device for shaping laser radiation (2), with a first array (7) of optical elements for deflecting and/or imaging and/or collimating the laser radiation (2), the first array (7) having a plurality of optical elements arranged side by side in a first direction (X), and a second array (8) of optical elements for deflecting and/or imaging and/or collimating the laser radiation (2), the second array (8) having a plurality of optical elements arranged side by side in the second direction (Y), wherein the optical elements of at least one of the arrays (7, 8) are mirror elements (9, 10).

The present invention relates to a device for shaping laser radiation. The application claims priority to DE 10 2016 102 591.7 filed on Feb. 15, 2016, which is incorporated by reference.

### BACKGROUND OF THE INVENTION

### Definitions

In the propagation direction of the laser radiation is meant to indicate a mean propagation direction of the laser radiation, in particular when the laser radiation is not a plane wave, or is at least is partially divergent. A laser beam, light beam, partial beam or beam does not, unless expressly stated otherwise, refer to an idealized beam of geometric optics, but to a real light beam, such as a laser beam with a Gaussian profile or a top hat profile, which does not have an infinitesimally small, but rather an extended beam cross-section. Light should not only refer to the visible spectral range but also the infrared and ultraviolet spectral range.

A device of the aforementioned type is known, for example, from WO 2015/091392 A1. With the device described therein, a transparent component with an array of cylindrical lenses on its entrance surface and its exit surface is used for shaping the laser radiation. The laser radiation emerging from the exit surface is coupled by the component into an optical fiber. In this case, the entrance angles of the peripheral rays limit the efficiency of the device. In addition, coatings are required that achieve good transmission over a wide angular range. The peripheral angles may be reduced by selecting glass with a high refractive index. At the same time, however, the usable wavelength range of a given design decreases.

The present invention addresses the problem of providing a device of the aforementioned type wherein a high coupling efficiency can also be achieved with glass having a low index of refraction.

This is achieved according to the invention with a device of the aforementioned type having the characterizing features of claim 1. The dependent claims recite preferred embodiments of the invention.

### BRIEF SUMMARY OF THE INVENTION

According to claim 1, the optical elements of at least one of the arrays are constructed as mirror elements. The mirror elements of the first and/or the second array may be separated from one another or may transition seamlessly into each other. Thus, an uninterrupted reflecting surface should also be regarded as an array of mirror elements. In this case, the boundaries of the mirror elements may be only imaginary lines.

A refractive surface of the device according to the prior art may be replaced by a reflecting surface, or a refractive and a reflecting surface. “Surface” may hereby refer to an optical element of the device—for example, the coupling-in optics for an emitter. In the first case, the coupler can be used over an extended wavelength range.

For example, the laser beams of the emitters may enter the device through a planar surface and may each be reflected by an internal hollow surface which is specially adapted to the individual emitter (at this point the device is convex from the outside) and may thereby be collimated and for example be deflected by 90°. With a completely reflective coupler, the sequential order is reversed upon exit: Each of the laser beams is focused by an internal hollow surface and, for example, deflected again by 90° before exiting from the device.

Alternatively, the laser beams of the emitters may be incident on reflecting hollow surfaces (for example, off-axis paraboloids), which deflect these laser beams to additional hollow surfaces and thereby collimate them. The second hollow surfaces then focus the laser beams onto a fiber core.

The entrance surfaces of the devices need not be planar. The direction of the incoming laser radiation can have an arbitrary orientation in relation to the exiting laser radiation. There may also be more than two internal reflections.

The device may include a component in which the mirror elements are formed, causing internal reflections. In this case, the component in which the mirror elements are formed may have an entrance surface and an exit surface; in particular, the entrance surface and/or the exit surface may be curved surfaces.

The device may include a component with an outer side on which the first array and the second array are arranged, wherein the arrays are accessible from the same side, so that, within the context of manufacturing the device, the mirror elements can formed from a single side.

All of the optical elements may be mirror elements or the device may include both mirror elements and lens elements. In particular, the device may include at least one array, preferably two arrays, of mirror elements, and in particular additionally at least one array, preferably two arrays, of lens elements.

### BRIEF DESCRIPTION OF THE DRAWINGS

The invention will now be described in more detail with reference to the appended drawings which shows in:

FIG. 1 a schematic side view of a first embodiment of a device according to the invention;

FIG. 2 a side view of the device according to FIG. 1, rotated with respect to FIG. 1;

FIG. 3 a schematic side view of a second embodiment of a device according to the invention;

FIG. 4 a schematic perspective view of a third embodiment of a device according to the invention; and

FIG. 5 a perspective view of the device according to FIG. 4, rotated with respect to FIG. 4.

### DETAILED DESCRIPTION OF THE INVENTION

In the figures, identical or functionally identical parts or light beams are provided with identical reference symbols. Furthermore, a Cartesian coordinate system is shown in one of the figures for better orientation.

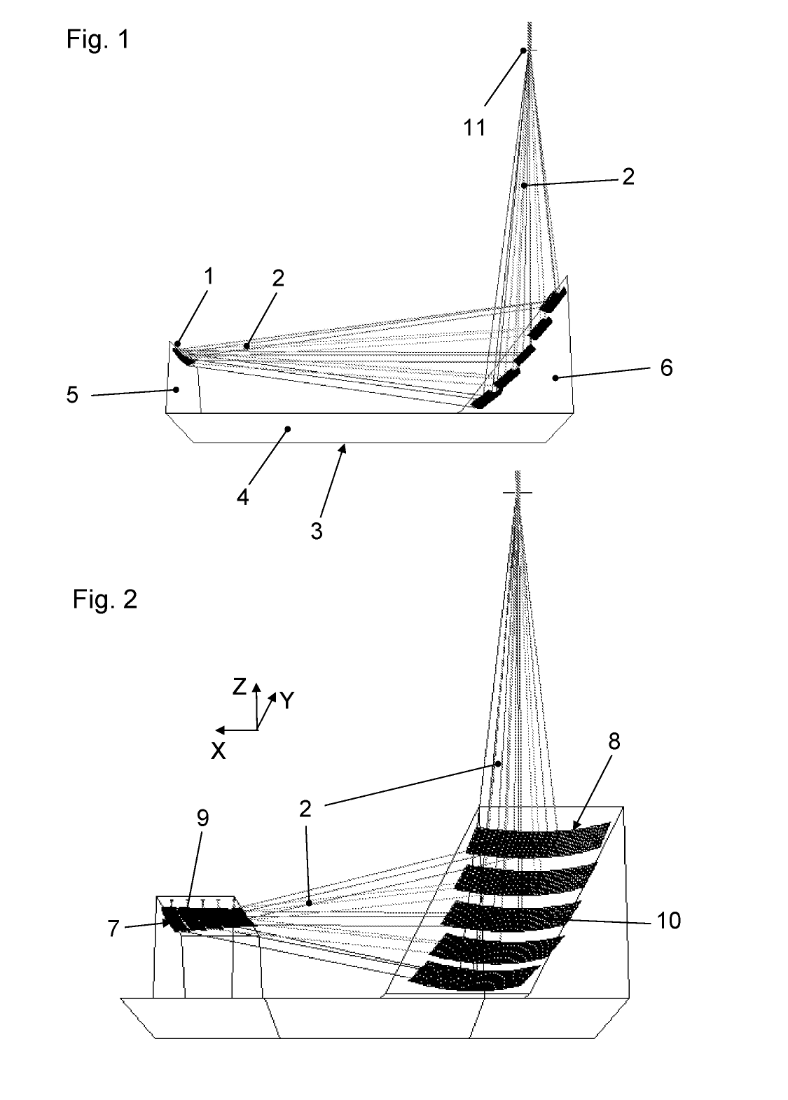

In the embodiment illustrated in FIG. 1 and FIG. 2, five emitters 1 of a laser diode bar are schematically depicted, from which laser radiation 2 emanates. The device according to the invention of this embodiment includes a substantially U-shaped component 3 which has a base 4 and two projections 5, 6 extending from the base 4 on opposite sides.

An array 7, 8 of mirror elements 9, 10 is arranged on each of the projections 5, 6. The mirror elements 9, 10 are designed as reflecting regions of the outer sides of the projections 5, 6, so that the laser radiation 2 does not enter the component 3.

The mirror elements 9, 10 are shaped surfaces of the component which are provided with a reflective coating. In FIG. 1 and FIG. 2, the mirror elements 9, 10 are arranged on surfaces which are accessible from above, thus simplifying the manufacture of the mirror elements since for shaping the surfaces of the mirror elements the material needs to be pressed, for example, only from one side.

FIG. 1 and FIG. 2 show that the mirror elements 9 of the first array 7 are smaller than the mirror elements 10 of the second array 8. It is also evident that the mirror elements 9, 10 of the two arrays 7, 8 are designed as hollow mirrors, so that the surface with a reflective coating is always concave.

The laser radiation 2 emanating from the emitters 1 is reflected by the first array 7 of mirror elements 9 onto the second array 8 of mirror elements 10. The laser radiation 2 is reflected by the second array 8 onto the entrance surface 11 of an optical fiber (not shown). Each of the laser radiations 2 of the individual emitters 1 may be collimated by a corresponding one of the mirror elements 9 of the first array 7. Each of these collimated laser radiations 2 may be deflected by a corresponding one of the mirror elements 10 of the second array 8 toward the fiber core of the optical fiber and focused onto the entrance surface 11.

The design according to FIG. 1 and FIG. 2 allows the laser radiation 2 to be shaped substantially independent of the wavelength because the laser radiation 2 does not pass through the component 3. However, wavelength dependencies can be caused by the choice of the reflective coating.

The mirror elements 9, 10 of the arrays 7, 8 can be designed so as to deflect the laser radiation, as described in WO 2015/091392 A1 for the lens arrays. WO 2015/091392 A1 is hereby incorporated into the present application by reference.

The mirror elements 9 of the first array 7 are arranged side by side in a first direction which corresponds to the X direction of the Cartesian coordinate system indicated in FIG. 2. The mirror elements 10 of the second array 8 are arranged side by side in a second direction which corresponds to the Y direction of the Cartesian coordinate system indicated in FIG. 2. The second direction Y may be perpendicular to the first direction X. Z denotes in this coordinate system the mean propagation direction of the laser radiation reflected by the second array 8.

The mirror elements 9 of the first array 7 are offset relative to one another in the second direction Y, whereas the mirror elements 10 of the second array 8 are offset relative to one another in the first direction X.

In particular, the number of mirror elements 9 of the first array 7 corresponds to the number of mirror elements 10 of the second array 8 or to the number of emitters 1 of the laser diode bar. The first array 7 and/or the second array 8 may be designed such that the laser radiation reflected by a mirror element 9 of the first array 7 is reflected precisely by a single mirror element 10 of the second array 8.

The mirror elements 9 of the first array 7 are designed in particular as cylindrical mirrors or as cylinder-like mirrors, with their cylinder axes extending at least partially in the X direction. The cylinder axis of the central mirror element 9 is, for example, parallel to the X direction, while the cylinder axes of the other mirror elements 9 enclose with the X-direction an angle greater than 0° or smaller than 0°.

The mirror elements 10 of the second array 8 are also designed in particular as a cylindrical mirror or as cylinder-like mirrors, wherein their cylinder axes extend at least partially in the Y direction. The cylinder axis of the central mirror element 10 is, for example, parallel to the Y direction, while the cylinder axes of the other mirror elements 10 enclose with the Y direction an angle greater than 0° or smaller than 0°.

Moreover, the mirror elements 9 of the first array 7 may each be tilted with respect to one another, so that each of the mirror elements 9 has an orientation that is different from the orientation of the other mirror elements 9. The mirror elements 9 of the first array 7 may here be tilted in the Y direction.

Furthermore, the mirror elements 10 of the second array 8 may each be tilted differently with respect to one another, so that each of the mirror elements 10 has an orientation that is different from the orientation of the other mirror elements 10. The mirror elements 10 of the second array 8 may here be tilted in the X-direction.

The illustrated device is able to shape the laser radiation 2 emanating from the emitters 1 of the laser diode bar (not shown). In particular, the X direction corresponds in this case to the slow axis and the Y direction to the fast axis of the laser diode bar.

The mirror elements 9 of the first array 7 and the mirror elements 10 of the second array 8 each operate to deflect the incident laser radiation 2 as well as to image or collimate the laser radiation 2.

For example, the mirror elements 9 of the first array 7 may hereby image the laser radiation 2 emanating from the individual emitters 1 onto the entrance surface 11 of the optical fiber with respect to the fast axis or the Y direction.

At the same time, the different orientation of the cylinder axes of the out-of-center mirror elements 9 of the first array 7 causes the laser radiation 2 emanating therefrom to be deflected in the X direction toward the optical axis and impinge on the mirror elements 10 of the second array 8. In addition, the respective different tilts of the mirror elements 9 of the first array 7 cause the laser radiation 2 emanating therefrom to be deflected upwards and downwards in the Y direction away from the optical axis and impinge on the corresponding mirror elements 10 of the second array 8.

Furthermore, for example, the mirror elements 10 of the second array 8 are able to image the laser radiation 2 emanating from the individual emitters 1 on the entrance surface 11 of the optical fiber with respect to the slow axis or the X direction, respectively.

At the same time, the different orientation of the cylinder axes of the out-of-center mirror elements 10 of the second array 8 causes the laser radiation 2 emanating from the outer mirror mirrors 9 of the first array 7 to be deflected in the X direction so as to extend in a YZ plane (see FIG. 2). In addition, the respective different tilts of the mirror elements 10 of the second array 8 cause the laser radiation 2 emanating from the out-of-center mirror elements 9 of the first array 7 to be deflected upwards and downwards toward the optical axis in the Y direction and impinge on the entrance surface 11 of the optical fiber.

Alternatively, the mirror elements 9 of the first array 7 and/or the mirror elements 10 of the second array 8 may not image, but rather collimate the laser radiation 2 emanating from the individual emitters 1. The laser radiation collimated with respect to the slow axis and the fast axis can thereafter be focused, for example, onto the entrance surface 11 of an optical fiber by using low-cost, spherical optics.

Instead of a configuration as a cylindrical mirror or a cylinder-like mirror, the mirror elements 9, 10 of the first and/or of the second array 7, 8 may also have curvatures in both the X direction and the Y direction. The surfaces of the mirror elements 9, 10 can herein be described, for example, by mixed polynomials which do not have exclusively even terms for each axis, but also mixed terms in X and Y. Odd terms in X and Y of an order higher than only the first order are also possible.

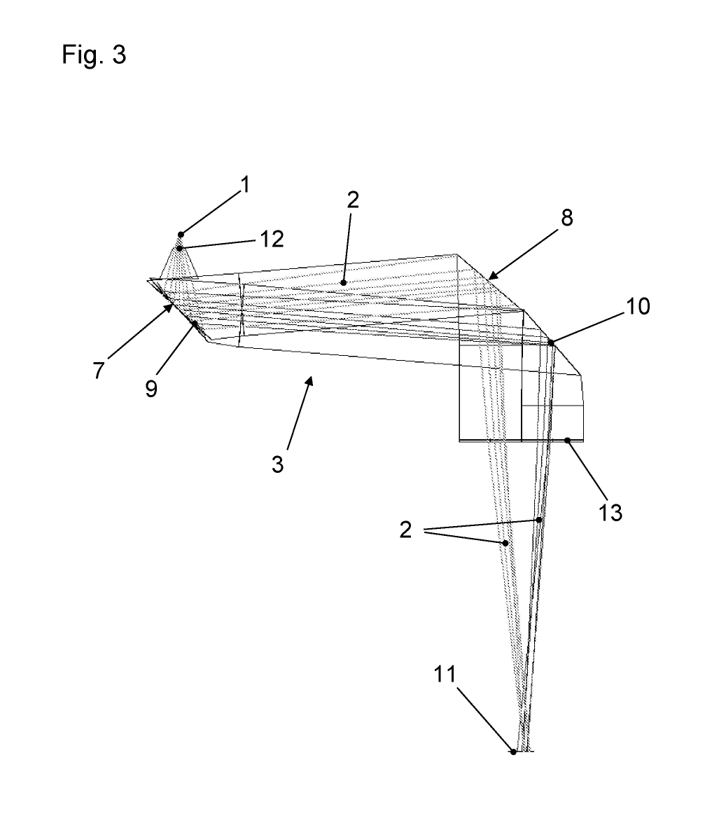

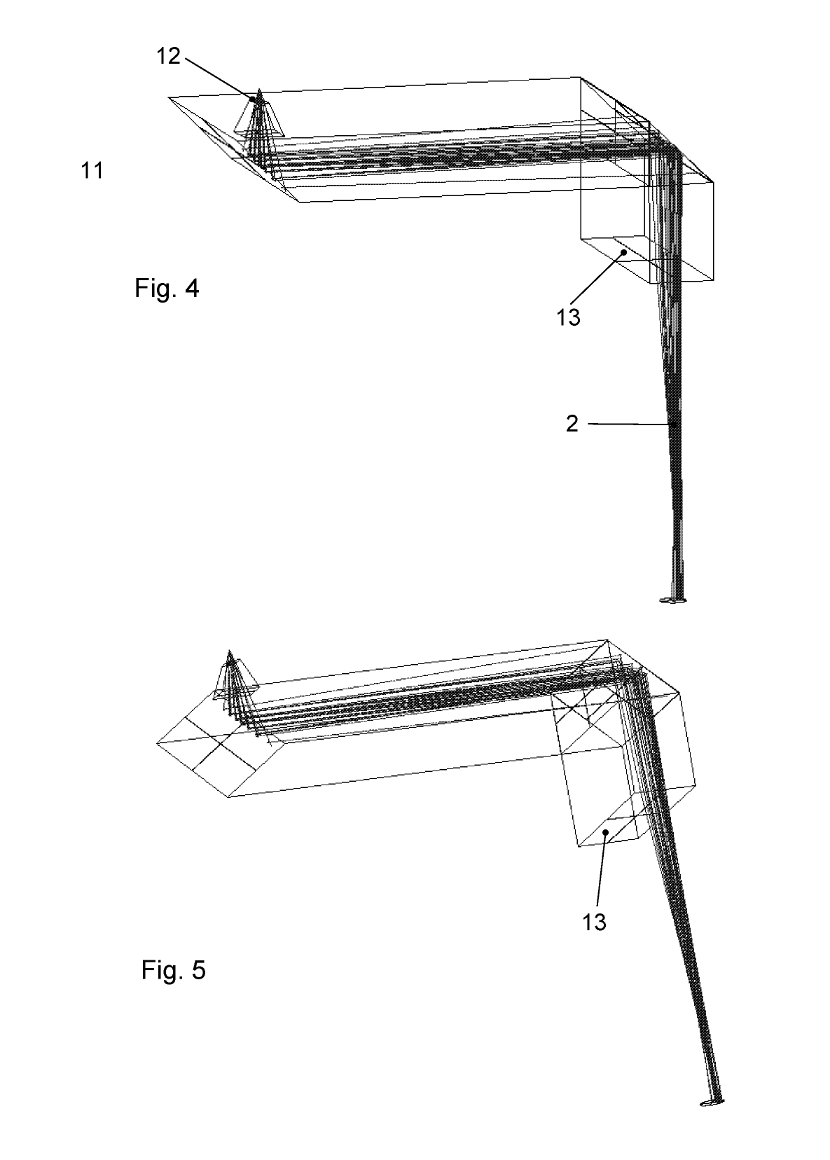

FIG. 3, on the one hand, and FIG. 4 and FIG. 5, on the other hand, show exemplary embodiments where the mirror elements 9, 10 are not arranged on the outer side of the component 3 but inside the component 3, so that internal reflections occur.

FIG. 3 shows a planar entrance surface 12 and a likewise planar exit surface 13 for the laser radiation. However, the entrance surface 12 and/or the exit surface 13 may also be formed as curved surfaces and may, for example, have a suitable acylindrical or aspherical shape.

The laser radiation 2, which entered the component 3 through the entrance surface 12, is reflected on the surface forming the first array 7, which is suitably shaped and, if desired, coated from the outside, and is deflected and collimated. The mirror elements 9 of the first array 7 may be separated from one another or may seamlessly transition into one another.

The surface forming the second array 8, which is also suitably shaped and optionally coated from the outside, again reflects the laser radiation 2. This surface forming the second array 8 may already have focusing or/and beam-shaping properties. The mirror elements 10 of the second array 8 may also be separated from one another or may seamlessly transition into one another.

The surfaces forming the first array 7 and the second array 8 are, in particular, convex.

The laser radiation exits from the component 3 through the exit surface 13. In the exemplary embodiment shown in FIG. 4 and FIG. 5, the exit surface 13 has a curvature with a shape that in particular causes or supports focusing.

1. A device for shaping laser radiation (2), comprising:
a first array (7) of optical elements for deflecting and/or imaging and/or collimating the laser radiation (2), the first array (7) comprising a plurality of optical elements arranged side by side in a first direction (X), wherein the first array (7) is constructed such that by a first of the optical elements of the first array (7) the laser radiation (2) is deflected by a first one of the optical elements of the first array (7) with respect to the first direction (X) and/or with respect to a second direction (Y), which is different from the first direction (X), at a different angle than by a second of the optical elements of the first array (7), and
a second array (8) of optical elements for deflecting and/or imaging and/or collimating the laser beam (2), the second array comprising a plurality of optical elements arranged side by side in the second direction (Y), wherein the second array (8) is constructed such that the laser radiation (2) is deflected by a first one of the optical elements of the second array (8) with respect to the first direction (X) and/or with respect to the second direction (Y) at a different angle than a second of the optical elements of the second array (8),
wherein the optical elements of at least one of the arrays (7, 8) are mirror elements (9, 10).

2. The device according to claim 1, wherein the device comprises a component (3), in which the mirror elements (9, 10) are formed so that internal reflections take place.

3. The device according to claim 2, wherein the component (3), in which the mirror elements (9, 10) are formed, comprises an entrance surface (12) and an exit surface (13).

4. The device according to claim 1, wherein the device comprises a component (3), with the first array (7) and the second array (8) arranged on the outside of the component (3), wherein the arrays (7, 8) are accessible from the same side, so that the mirror elements (9, 10) can be shaped from one side during manufacture of the device.

5. The device according to claim 1, wherein all of the optical elements are mirror elements (9, 10) or that the device comprises both mirror elements (9, 10) and lens elements.

6. The device according to claim 1, wherein the device comprises at least one array (7, 8), of mirror elements (9, 10) and at least one array of lens elements.

7. The device according to claim 1, wherein the first array (7) and/or the second array (8) are designed such that laser radiation (2) reflected by an optical element of the first array (7), or laser radiation (2) passing through an optical element of the first array (7), is reflected by exactly one optical element of the second array (8) or passes through exactly one optical element of the second array (8).

8. The device according to claim 1, wherein the optical elements of the first array (7) are offset relative to one another in the second direction (Y) and/or that the optical elements of the second array (8) are offset with respect to one another in the first direction (X).

9. The device according to claim 1, wherein the optical elements of the first array (7) and/or the optical elements of the second array (8) are designed as cylindrical mirrors or cylindrical lenses or cylinder-like mirrors or lenses.

10. The device according to claim 9, wherein at least one of the cylinder axes of the cylindrical mirrors or of the cylindrical lenses or of the cylinder-like mirrors or lenses of the first array (7) are oriented at an angle different from 0° and different from 180°, relative to at least one of the cylinder axes of the cylinder axes of the cylindrical mirrors or of the cylindrical lenses or of the cylinder-like mirrors or lenses of the second array (8).

11. The device according to claim 9, wherein
the cylinder axes of the cylindrical mirrors or of the cylindrical lenses or of the cylinder-like mirrors or lenses of the first array are either parallel to the first direction (X) or enclose an angle of less than 45°, with the first direction (X) and/or that
the cylinder axes of the cylindrical mirrors or of the cylindrical lenses or of the cylinder-like mirrors or lenses of the second array (8) are either parallel to the second direction (Y) or enclose an angle of less than 45° with the second direction (Y).

12. The device according to claim 9, wherein
the cylinder axes of at least two of the cylindrical mirrors or of the cylindrical lenses or of the cylinder-like mirrors or lenses of the first array (7) enclose with one another an angle greater than 0° and less than 25° and/or that
the cylinder axes of at least two of the cylindrical mirrors or of the cylindrical lenses or of the cylinder-like mirrors or lenses of the second array (8) enclose with one another an angle greater than 0° and less than 25°.

13. The device according to claim 1, wherein the device is used for shaping radiation emanating from a laser diode bar or a stack of laser diode bars, wherein the first direction (X) corresponds to the slow axis and the second direction (Y) corresponds to the fast axis, or wherein the second direction (Y) corresponds to the slow axis and the first direction (X) corresponds to the fast axis.

14. The device according to claim 13, wherein
at least one of the cylindrical mirrors or of the cylindrical lenses or of the cylinder-like mirrors or lenses of the first array is designed so as to be able to image the laser radiation emitted from an emitter of the laser diode bar or of the stack of laser diode bars with respect to the second direction (Y) onto the entrance surface of an optical fiber or to collimate the same with respect to the second direction (Y) and/or
at least one of the cylindrical mirrors or of the cylindrical lenses or of the cylinder-like mirrors or lenses of the second array (8) is designed so as to be able to image the laser radiation emitted from an emitter of the laser diode bar or of the stack of laser diode bars with respect to the first direction (X) onto the entrance surface of an optical fiber or to collimate the same with respect to the first direction (X).

15. The device according to claim 1, wherein at least one of the optical elements of the first array (7) and/or that at least one of the optical elements of the second array (8) are curved with respect to both the first direction (X) and the second direction (Y).

16. The device according to claim 1, wherein at least one of the optical elements of the first array (7) and/or at least one of the optical elements of the second array (8) are designed as free-form surfaces.

17. The device according claim 1, wherein the mirror elements (9, 10) of the first and/or of the second array (7, 8) are separated from one another or transition seamlessly into each other.

18. The device according to claim 3, wherein the entrance surface (12) and/or the exit surface (13) are curved surfaces.

19. The device according to claim 10, wherein the angle is 90°.

20. The device according to claim 11, wherein the cylinder axes of the cylindrical mirrors or of the cylindrical lenses or of the cylinder-like mirrors or lenses of the first array enclose the angle that is less than 35°.

21. The device according to claim 11, wherein the cylinder axes of the cylindrical mirrors or of the cylindrical lenses or of the cylinder-like mirrors or lenses of the first array enclose the angle that is less than 25°.

22. The device according to claim 11, wherein the cylinder axes of the cylindrical mirrors or of the cylindrical lenses or of the cylinder-like mirrors or lenses of the second array (8) enclose the angle of less than 35°.

23. The device according to claim 11, wherein the cylinder axes of the cylindrical mirrors or of the cylindrical lenses or of the cylinder-like mirrors or lenses of the second array (8) enclose the angle of less than 25°.

24. The device according to claim 12, wherein the cylinder axes of at least two of the cylindrical mirrors or of the cylindrical lenses or of the cylinder-like mirrors or lenses of the first array (7) enclose with one another the angle greater than 0° and less than 15°.

25. The device according to claim 12, wherein the cylinder axes of at least two of the cylindrical mirrors or of the cylindrical lenses or of the cylinder-like mirrors or lenses of the first array (7) enclose with one another the angle greater than 0° and less than 10.

26. The device according to claim 12, wherein the cylinder axes of at least two of the cylindrical mirrors or of the cylindrical lenses or of the cylinder-like mirrors or lenses of the second array (8) enclose with one another the angle greater than 0° and less than 15°.

27. The device according to claim 12, wherein the cylinder axes of at least two of the cylindrical mirrors or of the cylindrical lenses or of the cylinder-like mirrors or lenses of the second array (8) enclose with one another the angle greater than 0° and less than 10°.

28. The device according to claim 15, wherein all of the optical elements of the first array (7) and/or that all of the optical elements of the second array (8) are curved with respect to both the first direction (X) and the second direction (Y).

29. The device according to claim 16, wherein all of the optical elements of the first array (7) and/or all of the optical elements of the second array (8) are designed as free-form surfaces.

30. The device according to claim 1, wherein the laser radiation (2) is deflected by the first one of the optical elements of the first array (7) with respect to the first direction (X) and/or with respect to a second direction (Y), which is perpendicular to the first direction.

31. The device according to claim 6, wherein the device comprises two arrays (7, 8), of mirror elements (9, 10) and additionally two arrays of lens elements.

32. The device according to claim 7, wherein the number of optical elements of the first array (7) corresponds to the number of optical elements of the second array (8).
